(19) United States
(12) Patent Application Publication
(10) Pub. No.: US 2005/0155995 A1
(43) Pub. Date: Jul. 21, 2005

(54) Baby carrier

(75) Inventor: Hyun-Joo Lee, Seoul (KR)

Correspondence Address: ST. ONGE STEWARD JOHNSTON & REENS, LLC, 986 BEDFORD STREET, STAMFORD, CT, 06905-5619, US

(73) Assignee: Mamas & Papas Co., Ltd., Seoul (KR)

(21) Appl. No.: 11/022,729

(22) Filed: Dec. 27, 2004

(30) Foreign Application Priority Data
Dec. 26, 2003 (KR) 2003/40223
Jan. 13, 2004 (KR) 2004/2160

(51) Int. Cl. A61G 1/00; B62B 1/00; B62B 3/00; B62B 5/00; B62B 7/00; B62B 9/00

(52) U.S. Cl. 224/160

(57) ABSTRACT

A baby carrier is provided. The baby carrier includes a double backrest having a ventilation property, a buttocks support connected to a lower portion of the backrest, a shoulder belt having one end connected to both sides of the backrest and the other end connected to both sides of the buttocks support, a length of the shoulder belt being length-adjustable, and a backplate removably installed in the backrest.

This application claims priority of pending Korean Patent Application Nos. 2003-40223 filed on Dec. 26, 2003 and 2004-2160 filed on Jan. 13, 2004.

### FIELD OF THE INVENTION

The present invention relates to a baby carrier, and more particularly, to a baby carrier that can be used regardless of seasons, in which a backrest is ventilative and a ventilation blocking member is detachably attached to the backrest. Also, the present invention relates to a baby carrier in which a receiving unit capable of receiving articles for baby is removably connected to thereby provide a backpack function.

### DESCRIPTION OF THE RELATED ART

A baby carrier has been widely used to wrap both a guardian and a baby in such a state that the guardian piggybacks the baby. The baby carrier has a blanket and a string.

However, it is difficult for a novice to use such a baby carrier. Also, there is a problem in the safety of the baby. Accordingly, various shapes of the baby carrier are proposed for providing a convenience to both the guardian and the baby.

In recent years, there has been proposed a baby carrier including a chair-shaped backrest, a buttocks support connected to a lower portion of the backrest, and shoulder belts respectively having a male holder and a female holder. Thus, even an inexperienced guardian can easily piggyback a baby and both hands can be free.

However, such a baby carrier has a problem in that it is badly ventilated because it is made of texture.

Since a baby's skin is soft, a prickly heat may often occur during the summer season. Also, since the baby is weak in immunity during the winter season, the guardian must take special care of heat insulation.

Accordingly, in order to meet these requirements, a ventilative thin cloth is used in the summer season, while a heat-insulating thick cloth is used in the winter season. However, since the baby carrier according to the present invention does not consider these points, it is badly ventilated in the summer season and it is poorly heat-insulated in the winter season.

These problems can be solved by separately purchasing a baby carrier made of a thin cloth and a baby carrier made of a thick cloth. However, in this case, a purchase price is excessive. Also, as the baby grows up, the use duration of the baby carrier is not long. Thus, it is inefficient to purchase a lot of baby carriers in a modern times when there is less opportunity of hand-downs in a small family.

When the guardian goes out while piggybacking the baby, he or she must carry a variety of articles for baby. If carrying a separate backpack, the guardian cannot act freely. To solve this problem, a baby carrier having a backpack that can receive the articles for baby.

However, the baby carrier having the backpack is not elegant in its appearance. Even when the backpack is unnecessary to carry, there is a difficulty in use since the backpack is not separated and a volume is also increased.

Further, when the baby carrier is partially dirty, the baby carrier must be wholly washed, which is very troublesome.

### SUMMARY OF THE INVENTION

An object of the present invention is to provide a baby carrier that can be used regardless of seasons.

Another object of the present invention is to provide a baby carrier that can selectively provide a backpack function.

A further another object of the present invention is to provide a baby carrier in which only a dirty portion can be washed separately.

According to one aspect of the present invention, there is provided a baby carrier including: a double backrest having a ventilation property; a buttocks support connected to a lower portion of the backrest; a shoulder belt having one end connected to both sides of the backrest and the other end connected to both sides of the buttocks support, a length of the shoulder belt being length-adjustable; and a backplate removably installed in the backrest.

The baby carrier may further include a rear blocking member removably installed to cover a rear surface of the backrest.

The baby carrier may further include a receiving unit removably installed to cover a rear surface of the backrest, for receiving articles for baby.

The backrest may be made of gauze material, and the baby carrier may further include a headrest integrally formed at an upper portion of the backrest.

The baby carrier may further include a headrest having both ends removably connected to the shoulder belt and a central portion removably connected to the backrest.

### BRIEF DESCRIPTION OF THE DRAWINGS

The above objects and other advantages of the present invention will become more apparent by describing in detail preferred embodiments thereof with reference to the attached drawings in which:

FIG. 1 is a perspective view of a baby carrier according to the present invention;

FIG. 2 is a rear perspective view of the baby carrier according to the present invention; and

FIG. 3 is an exploded perspective view of the baby carrier according to the present invention.

### DETAILED DESCRIPTION OF PREFERRED EMBODIMENTS

Now, preferred embodiments of the present invention will be described in detail with reference to the accompanying drawings.

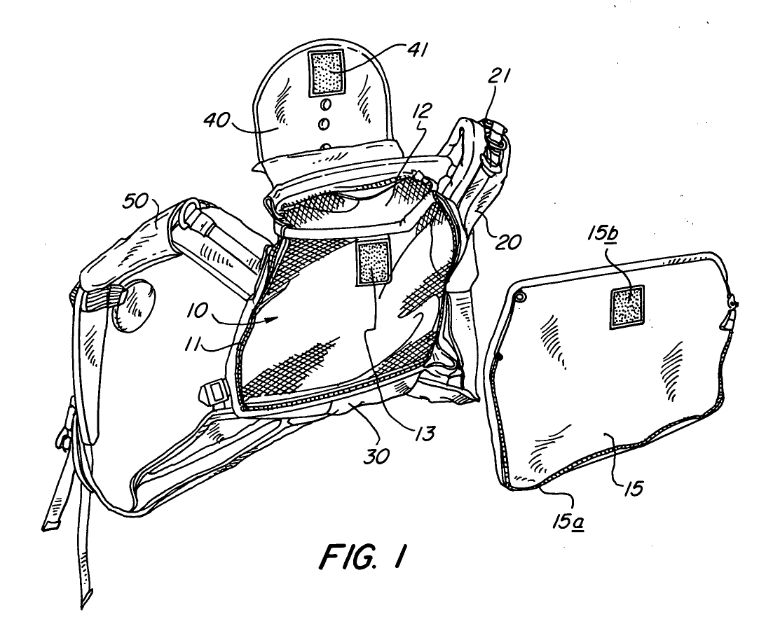

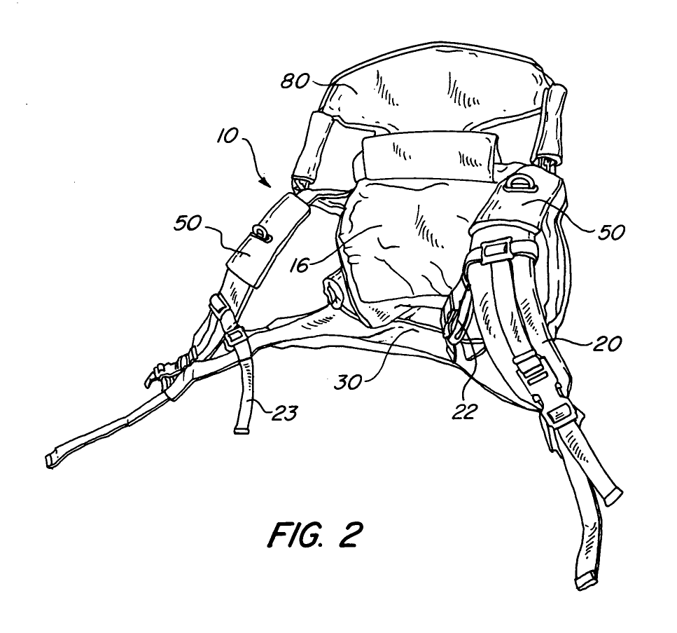

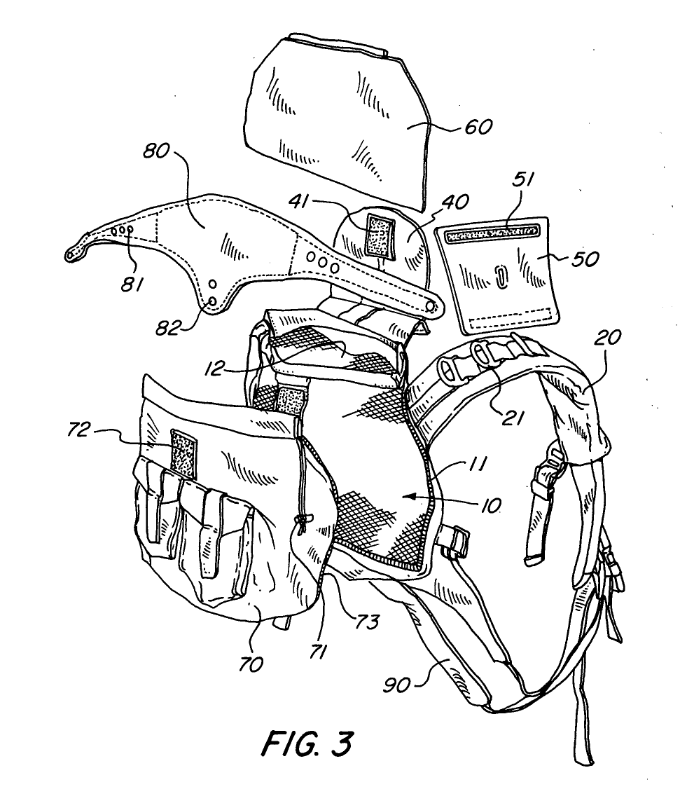

FIG. 1 is a perspective view of a baby carrier according to the present invention, FIG. 2 is a rear perspective view of the baby carrier according to the present invention, and FIG. 3 is an exploded perspective view of the baby carrier according to the present invention.

Referring to FIGS. 1 to 3, the baby carrier according to an embodiment of the present invention includes a double ventilative backrest 10, shoulder belts 20 fixed on both sides of the backrest 10, a buttocks support 30 connected to a lower portion of the backrest 10 and having both sides removably connected to the shoulder belts 20, and a backplate 60 received in the double backrest 10.

Also, a headrest 40 is integrally formed at an upper portion of the backrest 10. The headrest 40 is formed of a hard material and is folded so that it is connected to the backrest 10 through a connecting member 41.

Referring to FIG. 3, both ends of an auxiliary headrest 80 may be removably fixed to the shoulder belts 20. Also, a rear blocking member 15 shown in FIG. 1 may be removably connected to a rear surface of the backrest 10, or a front blocking member 16 shown in FIG. 2 may be removably connected to a front surface of the backrest 10.

In addition, instead of the rear blocking member 16, a receiving unit 70 can be separably connected to the rear surface of the backrest 10.

Hereinafter, a detailed structure and function of the respective elements will be described in detail.

The backrest 10 that supports a baby's back is ventilative and is formed in a double-layered structure. For example, a net-shaped gauze can be used as the backrest 10.

Referring to FIG. 3, an opening 12 is formed at an upper portion of the backrest 10 so as to insert the backplate 60, zipper 11 is formed at rear edges except the opening 12 so as to install a receiving unit 70 or the rear blocking member 15.

Referring to FIG. 2, a button (not shown) is formed at a rear edge of the backrest 10, such that the front blocking member 16 is removably connected thereto.

The headrest 40 is integrally formed at an upper portion of the backrest 10 in a folded state. A Velcro tape 41 is provided at an inner side of the folded portion and a connecting button (not shown) is provided at an outer side.

In mounting the backrest 60, the headrest 40 is turned over and the backplate 60 is inserted into the double backrest 10. Then, the headrest 40 and the backrest 10 are connected using a connecting member, for example, Velcro tapes 41 and 13.

A pair of the shoulder belts 20 is provided to enable the guardian to wear the baby carrier on his or her shoulders. On end of the shoulder belts 20 is connected to both sides of the backrest 10 and the other end is removably connected to both sides of the buttocks support 30, and the shoulder belts 20 are preferably formed in a length-adjustable way.

Also, a plurality of connecting rings 21 are formed at an upper portion of the shoulder belt 20 such that both ends of the auxiliary headrest 80 are fixed thereto, and first auxiliary belts 22 and 23 for removably connecting the shoulder belts 20 are provided at a central portion, thereby preventing the shoulder belts 20 from sliding down.

The buttocks support 30 is formed perpendicular in a front direction at a lower portion of the backrest 10 to support the baby's buttocks. Referring to FIG. 3, a second auxiliary belt 90 is connected to a lower portion of the buttocks support 30 to support the buttocks support 30 and both ends are removably connected to a lower portion of the shoulder belts 20.

An auxiliary headrest 80 supports the baby's head and can be formed of a cushioned material for protecting the baby's head. Both ends of the auxiliary headrest 80 is fitted into the connecting ring 21 of the shoulder belt 20 to thereby fix the button 81, and a button 82 disposed at a central portion is connected to the connecting button of the headrest 40.

If necessary, the auxiliary headrest 80 can be used as the headrest, without the formation of the headrest 40.

Meanwhile, a spit collector 50 is provided at both upper portions of the shoulder belts 20 where the baby's mouth is often touched and are removably mounted by a Velcro tape 51 to enclose the shoulder belts 20. Since the spit collector 50 is easily contaminated, it is preferable to use a material that is easy to wash.

The rear blocking member 15 has a zipper 15a formed along the edges except an upper portion with a size corresponding to a ventilation portion of the backrest 10. Also, the rear block member 15 has a Velcro tape 15b at a rear side.

Accordingly, when installing the rear blocking member 15 at the backrest 10, the headrest 40 is turned over and the zipper 15a formed at the edge of the rear blocking member 15 is connected to the zipper 11. Then, the backrest 10 and the headrest 40 are connected together using a connecting member of the rear blocking member 15, for example, the Velcro tapes 41 and 15b.

In addition, the receiving unit 70 is detachably mounted on the rear surface of the backrest 10 to providing a receiving space for receiving the articles for baby.

In a preferred embodiment of the present invention, a zipper 73 is formed along the edges except the upper portion, such that it is connected to the zipper 11. A tightening member 71 whose entrance is adjustable is formed at an upper portion. A connecting member 72 is connected to the connecting member 41 of the headrest 40.

Accordingly, when installing the receiving unit 70 in the headrest 10, the headrest 40 is turned over and the zipper 73 formed at the edge of the receiving unit 70 is connected to the zipper 11. Then, the receiving unit 70 and the headrest 40 are connected together using the connecting member of the rear blocking member 15, for example, the Velcro tapes 41 and 72.

A use method of the baby carrier according to the present invention will be described below.

First, the guardian makes the baby's head face the headrest 40, the baby's buttocks put on the buttocks support 30, and the baby's legs pass through the shoulder belts 20 from an inside to an outside.

Then, the shoulder belt 20 is tied and a length of the shoulder belt 20 is adjusted so that the guardian and the baby doe not feel uncomfortable. The first auxiliary belt 22 is used to prevent the shoulder belt from sliding down.

When the receiving unit 70 is required in a long-time outing, the receiving unit 70 is installed by connecting the zippers 73 and 11, a milk bottle or handkerchief for the baby is received in the receiving unit 70, and the tightening member 71 is tightened.

Also, in the summer season, if the receiving unit 70 or the backplate 60 or the rear blocking member 15 or the front blocking unit 16 is not installed, the baby carrier is well ventilated due to the gauze backrest 10. In the winter season, the heat insulation effect can be obtained by installing the backplate 60 or the rear blocking member 15. In addition, the heat insulation effect can be improved by installing the front blocking member 16 and the receiving unit 70.

According to the present invention, the ventilative backrest alone is used in a hot whether, and a combination of the front blocking member, the backplate, the rear blocking member and the receiving unit can be selectively applied depending on an outside temperature.

Further, since most of the components are removable, only a dirty component can be separately washed.

As described above, the baby carrier according to the present invention includes a double ventilative backrest, which is formed of a gauze, and is properly used depending on the seasons by inserting the backplate or movably attaching the rear blocking member. Thus, one baby carrier can be used in the four seasons, thereby reducing a cost.

Further, since most of the components, including the auxiliary headrest, the spit collector, the receiving unit, the backplate and the front and rear blocking members, can be removable, only a dirty component can be separately washed.

While the present invention has been described in detail, it should be understood that various changes, substitutions and alterations can be made hereto without departing from the spirit and scope of the invention as defined by the appended claims.

1. A baby carrier comprising:
a double backrest having a ventilation property;
a buttocks support connected to a lower portion of the backrest;
a shoulder belt having one end connected to both sides of the backrest and the other end connected to both sides of the buttocks support, a length of the shoulder belt being length-adjustable; and
a backplate removably installed in the backrest.

2. The baby carrier of claim 1, further comprising a rear blocking member removably installed to cover a rear surface of the backrest.

3. The baby carrier of claim 1, further comprising a receiving unit removably installed to cover a rear surface of the backrest, for receiving articles for baby.

4. The baby carrier of claim 2, further comprising a receiving unit removably installed to cover the rear surface of the backrest, for receiving articles for baby.

5. The baby carrier of claim 1, wherein the backrest is made of gauze material.

6. The baby carrier of claim 1, further comprising a headrest integrally formed at an upper portion of the backrest.

7. The baby carrier of claim 6, further comprising a headrest having both ends removably connected to the shoulder belt and a central portion removably connected to the backrest.

8. The baby carrier of claim 1, further comprising a headrest having both ends removably connected to the shoulder belt and a central portion removably connected to the backrest.
